(19) United States
(12) Patent Application Publication
(10) Pub. No.: US 2017/0105437 A1
(43) Pub. Date: Apr. 20, 2017

(54) Whipped Food Topping

(71) Applicant: Rich Products Corporation, Buffalo, NY (US)

(72) Inventor: Jonathan Gordon, Narragansett, RI (US)

(73) Assignee: RICH PRODUCTS CORPORATION

(21) Appl. No.: 15/290,321

(22) Filed: Oct. 11, 2016

Related U.S. Application Data
(60) Provisional application No. 62/242,542, filed on Oct. 16, 2015.

(51) Int. Cl. A23L 9/20; A23P 30/40

(52) U.S. Cl. CPC A23L 9/24; A23P 30/40; A23V 2002/00

(57) ABSTRACT

An edible topping composition which is pourable at refrigeration and room temperatures. The edible topping composition includes a coconut component (i.e., coconut oil, coconut cream, and/or coconut milk), fat, stabilizer, sweetener, and water. One or more optional ingredients can also be used (e.g., milk protein or soy protein, emulsifiers, thickeners, salt, phosphate salt, flavoring, coloring, preservatives, etc.). The edible topping composition is whippable and, in a whipped form, has a smooth, non-greasy texture and is free of waxy mouth feel.

The present invention claims priority on Provisional Application Ser. No. 62/242,542 filed Oct. 16, 2015, which is incorporated herein by reference.

The invention relates generally to the field of edible compositions, particularly to edible topping compositions that have improved flavor, more particularly to edible topping compositions that have improved flavor, and still more particularly to non-dairy edible topping compositions that have improved flavor and which can be used as a topping on beverages, cakes, and other desserts, and which are whippable.

### BACKGROUND OF THE INVENTION

Non-dairy toppings are very popular in that such toppings have a similar taste to dairy toppings, but generally have a longer shelf life than dairy products. As such, there is a continued need to formulate improved non-dairy food toppings that have a similar taste as a dairy topping.

### SUMMARY OF THE INVENTION

The present invention is directed to an edible topping composition with improved flavor which can be used as a topping on food products (e.g., beverages, cakes and other desserts, etc.), is whippable, and has a smooth texture and desirable consistency. The edible topping composition contains a coconut component (i.e., coconut oil, coconut cream and/or coconut milk). The edible topping composition of the present invention can be used as a top level dairy-like topping for food products. As such, the edible topping composition of the present invention provides the dairy-like topping to bakeries that traditionally use partial or all dairy cream in dessert production (e.g., cakes, etc.) and desire to upgrade from an existing dairy blend or non-dairy whipped topping to the edible topping composition of the present invention. The edible topping composition of the present invention includes coconut oil, coconut cream and/or coconut milk; fat; stabilizer; sweetener and water. One or more optional ingredients can also be used (e.g., milk protein or soy protein, emulsifiers, thickeners, salt, phosphate salt, flavoring, coloring, preservatives, etc.).

The present invention provides an edible topping composition which includes an oil-in-water emulsion that is easily whippable at refrigeration temperatures (i.e., 33° F-45° F. and all values and ranges therebetween), and can be whipped into a confection having improved organoleptic characteristics. The edible topping composition has a smooth and non-greasy texture, non-waxy mouth feel and pleasurable organoleptic characteristics. The unwhipped food product is pourable at refrigeration and room temperatures and is therefore easily whippable to obtain confections including icings, toppings, fillings and the like. The whipped food product is smooth, non-greasy, easy to dispense for making decorations, and easy to clean up.

The invention also provides a method for preparing the edible topping composition. The method comprises the steps of mixing together water, coconut component, sweetener, and stabilizer, then optionally separately mixing fats. Add blend of water, sweetener, and stabilizer to blended fats and all other ingredients except acid and flavoring and mix ingredients together. Add flavoring and acid and then pasteurize mixture, cool mixture, homogenize mixture, and finally package mixture. The whippable product is a liquid and can be stored frozen.

The present invention also provides a method for obtaining a whipped confection from the edible topping composition. The product can be whipped by routine methods known in the art to form a whipped confection.

One non-limiting object of the present invention is the provision of an edible topping composition that includes an oil emulsion that includes a coconut component (i.e., coconut oil, coconut cream and/or coconut milk) that has improved flavor, a smooth texture, and a desirable consistency.

Another non-limiting object of the present invention is the provision of an edible topping composition that is dairy-free and has a taste and flavor that is close to a dairy topping.

Still another non-limiting object of the present invention is the provision of an edible topping composition that provides the natural creamy flavor and fresh milk taste of traditional dairy toppings.

Yet another non-limiting object of the present invention is the provision of an edible topping composition which is easily whippable at refrigeration temperatures, and can be whipped into a confection having improved organoleptic characteristics.

Another non-limiting object of the present invention is the provision of an edible topping composition that has a smooth and non-greasy texture, non-waxy mouth feel, and pleasurable organoleptic characteristics.

Still another non-limiting object of the present invention is the provision of an edible topping composition that is pourable at refrigeration and room temperatures and is therefore easily whippable to obtain confections including icings, toppings, fillings and the like.

Yet another non-limiting object of the present invention is the provision of an edible topping composition that is smooth, non-greasy, easy to dispense for making decorations, and easy to clean up.

Still yet another non-limiting object of the present invention is the provision of an edible topping composition that is a liquid and can be stored frozen, chilled, or at room or ambient temperature (i.e., 60° F-80° F.).

Another non-limiting object of the present invention is the provision of an edible topping composition that can be whipped by routine methods known in the art to form a whipped confection.

These and other objects and advantages will become apparent from the following description.

### DETAILED DESCRIPTION OF NON-LIMITING EMBODIMENTS

The present invention is directed to an edible topping composition with improved flavor which can be used as a topping on food products or as a creamer, is whippable, and has a smooth texture and desirable consistency. The edible topping composition contains a coconut component (i.e., coconut oil, creamed coconut, and/or coconut milk)

In one non-limiting example, the edible topping composition of the present invention includes water, coconut component, sweetener (sugar, syrup, etc.), and one or both of emulsifier and stabilizer. The edible topping can optionally include one or more of the following: additional fats, protein (e.g., milk protein, soy protein, etc.), thickeners, salt, phosphate salt, flavoring, coloring, preservatives, acidifiers, etc.

Generally, the water content is the largest weight percent component of the edible topping composition. In one non-limiting embodiment, the water content of the edible topping composition is at least about 40 weight percent. In another non-limiting embodiment, the water content of the edible topping composition is no more than about 70 weight percent. In still another non-limiting embodiment, the water content of the edible topping composition is about 45-65 weight percent (and all values and ranges there between), typically 50-60 weight percent, and more typically 50.01-56 weight percent. In one specific non-limiting formulation, the water content is greater than 50 weight percent of the edible topping composition.

Generally, the coconut component (i.e., coconut milk, creamed coconut, and/or coconut oil) content of the edible topping composition is at least 5 weight percent. In one non-limiting embodiment, the coconut component content of the edible topping composition is no more than about 30 weight percent. In still another non-limiting embodiment, the coconut component content of the edible topping composition is about 5-30 weight percent (and all values and ranges there between). In still another non-limiting embodiment, the coconut component content of the edible topping composition is about 8-25 weight percent, typically 10-20 weight percent, and more typically 12-18 weight percent. When the coconut component content includes coconut oil and coconut milk and/or creamed coconut, the content of the coconut oil generally constitutes the greatest weight percent of the components of the coconut component content. Generally, the coconut component content is greater than any other fat component in the edible topping composition. Generally, the weight ratio of the coconut component content to any other fat component in the edible topping composition is 1.1-5:1 (and all values and ranges therebetween), typically 1.2-4:1, and more typically 1.4:3:1.

Additional fats can be included in the edible topping composition. Non-limiting fats that can be used include non-dairy butter, cottonseed oil, corn oil, soybean oil, peanut oil, olive oil, palm oil, palm kernel oil, safflower oil, sunflower oil, avocado oil, mustard oil, peanut oil, rice bran oil, and/or sesame oil. When additional fats are used, generally the additional fat content is about 0.5-20 weight percent of the edible topping composition (and all values and ranges there between), and typically about 3-15 weight percent, more typically about 5-12 weight percent. In one specific non-limiting formulation, two or more additional fats are included in the edible topping composition.

Generally, the sweetener content of the edible topping composition is about 1-35 weight percent (and all values and ranges there between), typically about 5-30 weight percent, and more typically about 10-25 weight percent. The sweetener that can be used in the edible topping composition includes sugars (e.g., monosaccharides, disaccharides and polysaccharides). The sweetener may be comprised of one or more sugars, such as sucrose, fructose, dextrose; sugar syrups (e.g., corn syrup, rice syrup, glucose syrup, maple syrup, golden syrup, high-fructose corn syrup, etc.), and/or intensive sweeteners, such as aspartame, acetosulfame, alitame, saccharin, cyclamates, and trichloro sucrose. Bulking agents may optionally be included in the formulation to provide additional solids and provide body to the foam structure. Typical bulking agents are maltodextrin, polydextrose, polyglucose, xylitol, mannitol and sorbitol. For formulation calculations, all of these bulking agents are considered to be included in the sweetener component. In one non-limiting embodiment, the sweetener includes sucrose or sucrose-fructose combinations. In another non-limiting embodiment, the sweetener includes both sugar and sugar syrup. In one non-limiting formulation, the sweetener content of the edible topping composition is less than the fat content of the edible topping composition. Generally, the sweetener content is the second largest weight percent component of the edible topping composition; however, this is not required. Generally, the weight ratio of sweetener content to coconut component is 1.01-3:1 (and all values and ranges there between), typically 1.1-2.5:1, more typically 1.2-2:1, and still more typically 1.3-1.8:1.

The edible topping composition can generally include one or more emulsifiers. The one or more emulsifiers (when used) are present in the edible topping composition in an amount of at least about 0.01 weight percent. The content of the one or more emulsifiers in the edible topping composition generally does not exceed 5 weight percent. In one non-limiting embodiment, the content of the one or more emulsifiers in the edible topping composition (when used) is 0.01-5 weight percent (and all values and ranges therebetween). In another non-limiting embodiment, the emulsifier (when used) is present in the edible topping composition in an amount of about 0.2-2.5 weight percent, and more typically about 0.2-1.5 weight percent as permissible under FDA guidelines. Non-limiting examples of one or more emulsifiers than can be used include polyoxyethylene ethers of sorbitan monostearate (polysorbate 60) and polyoxyethylene ethers of sorbitan monooleate (polysorbate 80); span-20, span-40, span-60, span-80, lecithin; hydroxylated lecithin; mono, di, or polyglycerides of fatty acids, such as stearin and palmitin mono and diglycerides; polyoxyethylene ethers of fatty esters of polyhydric alcohols, or the polyoxyethylene ethers of sorbitan distearate; fatty esters of polyhydric alcohols such as sorbitan monostearate; polyglycerol esters of mono and diglycerides such as hexaglyceryl distearate; mono- and diesters of glycols such as propylene glycol monostearate, and propylene glycol monopalmitate, succinoylated monoglycerides; and the esters of carboxylic acids such as lactic, citric, and tartaric acids with the mono- and diglycerides of fatty acids such as glycerol lacto palmitate and glycerol lacto stearate, and calcium or sodium stearoyl lactylates and all members of the sucrose ester family thereof, all varieties of diacetyltartaric esters of fatty acids, “DATEMS”, and the like, and mixtures thereof. In one non-limiting embodiment, the emulsifier, when used, includes polysorbate 60, and/or polysorbate 80, and/or Admul (e.g., Admul MG40-04).

The edible topping composition can optionally include one or more stabilizers. The one or more stabilizers (when used) are present in the edible topping composition in an amount of at least about 0.01 weight percent. The content of the one or more stabilizers in the edible topping composition generally does not exceed 5 weight percent. In one non-limiting embodiment, the content of the one or more stabilizers in the edible topping composition (when used) is 0.01-5 weight percent (and all values and ranges therebetween). In another non-limiting embodiment, the stabilizer (when used) is present in the edible topping composition in an amount of about 0.1-2.5 weight percent, and more typically about 0.15-1.5 weight percent as permissible under FDA guidelines. Non-limiting examples of one or more stabilizers that can be used include hydrophilic colloids. The hydrophilic colloids can be natural, such as vegetable, or synthetic gums and may be, for example, carrageenan, guar gum, alginate, xanthan gum, locust bean gum, arabic gum, gellan gum, pectin, and the like or semi-synthetic such as methylcellulose, carboxy-methylcellulose, ethylcellulose, hydroxy-propylmethylcellulose (HPMC), and microcrystalline cellulose. In one non-limiting embodiment, the stabilizer (when used) includes carrageenan, guar gum, alginate, and/or xanthan gum.

The edible topping composition can optionally include one or more salts. The one or more salts (when used) are present in the edible topping composition in an amount of at least about 0.01 weight percent. The content of the one or more salts in the edible topping composition generally does not exceed 1 weight percent. In one non-limiting embodiment, the content of the one or more salts in the edible topping composition (when used) is 0.01-1 weight percent (and all values and ranges therebetween). The salts useful for the present invention are any edible salt that does not interfere with other ingredients or render an undesirable taste. Salts can generally act as buffers and/or as flavorants and/or preservatives. Examples of useful salts are common salt (sodium chloride), sea salt, sodium or potassium phosphates, citrates, chlorides, phosphate salt, sorbates, and the like.

The edible topping composition can optionally include one or more starches or modified starch. The one or more starches (when used) are present in the edible topping composition in an amount of at least about 0.1 weight percent. The content of the one or more starches in the edible topping composition generally does not exceed 5 weight percent. In one non-limiting embodiment, the content of the one or more starches in the edible topping composition (when used) is 0.1-5 weight percent (and all values and ranges therebetween). Non-limiting starches that can be used include starches obtained from potato, arrow root, corn, rice, wheat, waxy maize, sorghum, waxy sorghum and the like, or modified starch.

The edible topping composition can optionally include one or more proteins. The one or more proteins (when used) are present in the edible topping composition in an amount of at least about 0.1 weight percent. The content of the one or more proteins in the edible topping composition generally does not exceed 5 weight percent. In one non-limiting embodiment, the content of the one or more proteins in the edible topping composition (when used) is 0.1-5 weight percent (and all values and ranges there between). Non-limiting proteins that can be used include milk proteins such as isolated sodium, potassium or calcium caseinates, whey protein concentrates, alpha lactalbumin and beta lactoglobulin can be used. Vegetable proteins including, but not limited to, soy protein, pea protein, wheat protein, cottonseed protein, peanut protein, and corn protein are also useful. Meat proteins derived as soluble proteins from meat processing may also be used according to the practice of the invention.

The edible topping composition can optionally include one or more acidulants. The one or more acidulants (when used) is present in the edible topping composition in an amount of at least about 0.001 weight percent. The content of the one or more acidulants in the edible topping composition generally does not exceed 1 weight percent. In one non-limiting embodiment, the content of the one or more acidulants in the edible topping composition (when used) is 0.001-1 weight percent (and all values and ranges therebetween). Acidulants can be added to impart tartness, control pH and/or serve as a preservative for the edible topping composition. Non-limiting examples of acidulants that can be used include phosphoric acid, tartaric acid, malic acid, citric acid, fumaric acid, and the like.

The edible topping composition can optionally include one or more other ingredients such as flavoring agents, colorants, vitamins, minerals, etc. Suitable flavoring agents can be employed to impart vanilla, cream, chocolate, coffee, maple, spice, mint, butter, caramel, natural milk flavor, natural cream flavor, coconut, almond, fruit and other flavors. The flavoring (when used) is present in the edible topping composition in an amount of at least about 0.01 weight percent. The content of the flavoring in the edible topping composition generally does not exceed 1 weight percent. In one non-limiting embodiment, the content of the flavoring in the edible topping composition (when used) is 0.01-1 weight percent (and all values and ranges therebetween). The coloring (when used) is present in the edible topping composition in an amount of at least about 0.001 weight percent. The content of the coloring in the edible topping composition generally does not exceed 0.5 weight percent. In one non-limiting embodiment, the content of the coloring in the edible topping composition (when used) is 0.001-0.5 weight percent (and all values and ranges therebetween). The content of one or more vitamins and/or minerals in the edible topping composition (when used) is generally less than 0.5 weight percent.

Non-limiting examples of the edible topping composition in weight percent are as follows:

### EXAMPLE 1

| | |
|---|---|
| Water | 40-70% |
| Coconut oil | 5-30% |
| Creamed coconut and/or | 0-10% |
| coconut milk | |
| Non-dairy fat | 0-20% |
| Sweetener | 1-35% |
| Emulsifier | 0.01-5 |
| Stabilizer | 0.01-5 |
| Salt | 0.01-1% |
| Starch | 0-5% |
| Protein | 0-5% |
| Flavoring | 0.01-1% |
| Acidulant | 0.001-1% |
| Coloring | 0-0.5% |

### EXAMPLE 2

| | |
|---|---|
| Water | 45-60% |
| Coconut oil | 10-20% |
| Creamed coconut and/or | 0-10% |
| coconut milk | |
| Sunflower oil | 1-10% |
| Non-dairy butter | 1-10% |
| Sweetener | 1-15% |
| Sweetener (syrup) | 1-20% |
| Emulsifier | 0.1-2% |
| Stabilizer | 0.1-2% |
| Salt | 0.05-1% |
| Starch | 0-2% |
| Protein | 0-2% |
| Flavoring | 0.05-1% |
| Acidulant | 0.001-0.5% |
| Coloring | 0-0.5% |

### EXAMPLE 3

| | |
|---|---|
| Water | 50.01-55% |
| Coconut oil | 12-16% |
| Creamed coconut and/or | 0-10% |
| coconut milk | |
| Sunflower oil | 4-8% |
| Non-dairy butter | 2-6% |
| Sugar | 4-8% |
| Sweetener (syrup) | 12-18% |
| Emulsifier | 0.3-0.8% |
| Stabilizer | 0.1-0.4% |
| Salt | 0.05-0.2% |
| Starch | 0-1% |
| Protein | 0-1% |
| Flavoring | 0.1-0.5% |
| Acidulant | 0.01-0.05% |
| Coloring | 0-0.1% |

### EXAMPLE 4

| | |
|---|---|
| Water | 47-52% |
| Coconut oil | 12-16% |
| Creamed coconut | 0.01-10% |
| Sunflower oil | 4-8% |
| Non-dairy butter | 2-6% |
| Sugar | 6-12% |
| Sweetener (syrup) | 12-18% |
| Emulsifier | 0.3-0.9% |
| Stabilizer | 0.1-0.4% |
| Salt | 0.05-0.2% |
| Starch | 0-1% |
| Protein | 0-1% |
| Flavoring | 0.1-0.8% |
| Acidulant | 0.01-0.05% |
| Coloring | 0-0.1% |

### EXAMPLE 5

| | |
|---|---|
| Water | 52.86% |
| Coconut oil | 13.7% |
| Rice syrup solids | 15% |
| Sugar | 6.8% |
| High oleic sunflower oil | 6% |
| Creamed coconut | 4% |
| Admul MG40-04 | 0.7% |
| Natural vanilla ice cream flavor | 0.36% |
| Cream flavor | 0.15% |
| Carrageenan | 0.23% |
| Sea salt | 0.1% |
| Natural milk flavor | 0.08% |
| Tartaric acid | 0.018% |

One non-limiting process for forming the topping compositions of Examples 1-5 is as follows:

1) Measure the water; 2) Add rice syrup solids; 3) Pre-disperse carrageenan with sugar; 4) Slowly add sugar/gum blend with gentle agitation; 5) Preblend sunflower oil, melted coconut oil, melted coconut cream, and Admul; 6) Blend fats in with high shear to avoid air entrapment; 7) Add all other dry ingredients except acid; 7) Add flavors; 8) Add acid; 9) Pasteurize to 165° F.; 10) Cool to 70° F.; and 11) Homogenize at 4000/500 psi (Two Stage).

### EXAMPLE 6

| | |
|---|---|
| Water | 53.16% |
| Soymilk powder | 2% |
| Sunflower oil | 6% |
| Coconut oil | 15.4% |
| Creamed coconut | 0-8% |
| Sugar | 6.8% |
| Carrageenan | 0.23% |
| Rice syrup solids | 15% |
| Admul MG40-04 | 0.7% |
| Natural vanilla ice cream flavor | 0.36% |
| Sea salt | 0.1% |
| Cream flavor | 0.15% |
| Natural milk flavor | 0.08% |
| Tartaric acid | 0.018% |

One non-limiting process for forming the topping composition of Example 6 is as follows:

1) Hydrate soy in water for 15 minutes; 2) Add rice syrup solids; 3) Preblend sunflower oil, melted coconut oil, and Admul; 4) Blend fats into blend using high shear to avoid air entrapment; 5) Pre-disperse carrageenan with sugar; 6) Slowly add sugar/gum blend with gentle agitation; 7) Add all other dry ingredients except acid; 8) Add flavors; 9) Add acid; 10) Pasteurize to 165° F.; 11) Cool to 70° F.; and 12) Homogenize at 4000/500 psi (Two Stage).

### EXAMPLE 7

| | |
|---|---|
| Water | 52.36% |
| Coconut oil | 14.3% |
| Creamed coconut | 0-8% |
| Rice syrup solids | 15% |
| Sugar | 6.8% |
| Sunflower oil | 6% |
| Almond butter | 4% |
| Admul MG40-04 | 0.6% |
| Natural vanilla ice cream flavor | 0.36% |
| Cream flavor | 0.15% |
| Carrageenan | 0.23% |
| Sea salt | 0.1% |
| Natural milk flavor | 0.08% |
| Tartaric acid | 0.018% |

One non-limiting process for forming the topping composition of Example 7 is as follows:

1) Measure water; 2) Add rice syrup solids; 3) Pre-disperse carrageenan with sugar; 4) Slowly add sugar/gum blend with gentle agitation; 5) Preblend sunflower oil, melted coconut oil, almond butter, and Admul; 6) Blend fats in with high shear; 7) Add all other dry ingredients except acid; 8) Add flavors; 9) Add acid; 10) Pasteurize at 165° F. for 10 min; 11) Cool to 70° F.; and 12) Homogenize at 4000/500 psi (Two Stage).

### EXAMPLE 8

| | |
|---|---|
| Water | 49.56% |
| Carrageenan | 0.23% |
| Rice syrup solids | 15% |
| Creamed coconut | 4% |
| Coconut oil | 13.7% |
| Sunflower oil | 6% |
| Mono & Diglycerides Admul MG 40-40 | 0.7% |
| Sugar | 10.1% |
| Sea Salt | 0.1% |
| Milk flavor | 0.08% |
| Cream flavor | 0.15% |
| Ice cream flavor | 0.36% |
| Tartaric acid | 0.018% |

One non-limiting process for forming the topping composition of Example 8 is as follows:

1) Add water to batch tank and heat to 165° F.; 2) Add Carrageenan and rice syrup solids; 3) Add creamed coconut; 4) Add coconut oil; 5) Add sunflower oil; 6) Add Admul MG 40-40; 7) Add sugar; 8) Add sea salt; 9) Add milk flavor; 10) Add cream flavor; 11) Add ice cream flavor; 12) Add tartaric acid; 13) Heat mixture for at least 30 seconds; 14) Pasteurize at 165° F. for 10 min; 15) Cool to 70° F.; and 16) Homogenize at 4000/500 psi (Two Stage).

The edible topping composition of the present invention in an unwhipped state is a liquid at refrigeration and ambient temperatures. Accordingly, the edible topping composition is easily pourable at both refrigeration and ambient temperatures and may be used in manufacturing plants which are equipped to process liquids. The edible topping composition can be formed into a whipped topping. The edible topping composition in an unwhipped state can be stored frozen for over a year or can be stored refrigerated for at least up to nine months. The edible topping composition in a whipped state is stable in refrigerated conditions for at least 12 hours, typically for at least 24 hours, more typically for at least 2 days, and still more typically for at least a week. The edible topping composition in a whipped state is stable in ambient temperatures for at least 1 hour, typically for at least 2 hours.

The edible topping composition in a whipped state has a non-greasy texture and can be dispensed easily and cleaned up easily. The edible topping composition in a whipped state can be whipped to an overrun of at least about 150%, generally at least about 200%, and more typically up to or greater than about 300%.

A non-limiting process for forming the edible topping composition of the present invention is as follows:

1) Add water to batch tank; 2) Heat water to 165° F.; 3) Premix carrageenan with rice syrup solids; 4) Add premix to water; 5) Add creamed coconut; 6) Add coconut oil; 7) Add sunflower oil; 8) Add Admul; 9) Add liquid sugar; 10) Add sea salt; 11) Add milk flavor; 12) Add cream flavor; 13) Add ice cream flavor; 14) Add tartaric acid; 15) Pasteurize and/or homogenize; and 16) Cool product prior to homogenization.

The pasteurization generally occurs at a temperature of about 130-200° F. (e.g., 148° F.-167° F.); however, other temperatures can be used. Generally, the time of pasteurization is no more than 24 hours and typically less than about 80 minutes, and more typically at least about five minutes and typically less than about 60 minutes (e.g., 20 minutes); however, other times can be used. In addition to or in alternative to pasteurization, a UHT process can be used.

After the pasteurization or ultra-high temperature (UHT) thermal treatment, the edible topping composition can optionally be homogenized. For example, the dairy blend can be homogenized using one- or two-stage pressures with total pressures of 1000-7000 psi. Homogenization procedures are described in U.S. Pat. No. 6,203,841, which is incorporated herein by reference. The edible topping composition is generally cooled prior to homogenization.

After homogenization and/or pasteurization and/or UHT, the edible topping composition is then cooled to a temperature that is generally less than 20° C. (e.g., 0-10° C.). The cooling of the edible topping composition can be by a heat exchanger; however other or additional methods of cooling can be used.

After the edible topping composition is cooled, the cooled product is a liquid and is ready for use or packaging. If the product is packaged, the package can be stored on a shelf, in a refrigerated environment, or frozen. The frozen product can be thawed, typically under refrigerated temperatures and thereafter is ready for use.

Non-limiting processing parameters for a batch operation are set forth below:

Process Parameters - Batching

| | | Acceptance Criteria | | | | | | |
|---|---|---|---|---|---|---|---|---|
| | Sample | Individual | | | Average | | | |
| Parameter | Size | Min | Target | Max | Min | Target | Max | Units |

| | | | | |
|---|---|---|---|---|
| Cooling 1st Stage Product Temp | 162 | 165 | 168 | Degrees F. |
| Entry | | | | |
| Cooling 1st Stage Product Temp | 90 | 95 | 100 | Degrees F. |
| Exit | | | | |
| Cooling 1st Stage Water Tower | 70 | 76 | 32 | Degrees F. |
| Entry | | | | |
| Cooling 2nd Stage Product Temp | 90 | 95 | 99 | Degrees F. |
| Entry | | | | |
| Cooling 2nd Stage Product Temp | 42 | 45 | 48 | Degrees F. |
| Exit | | | | |
| Cooling 2nd Stage Water Temp | 33 | 33.5 | 35 | Degrees F. |
| Entry | | | | |
| Homgenizer Pressure 1st Stage | | 4,000 | | PSI |
| Homgenizer Pressure 2nd Stage | | 500 | | PSI |
| Homgenizer Pressure Total | | 4,500 | | PSI |
| Processing Rates | | 1,250 | | LB/MIN |
| Temperature Filler Bowl | 45 | 50 | 58 | Degrees F. |
| Temperature Holding Tank | 40 | 45 | 56 | Degrees F. |

Non-limiting properties of the edible topping composition of the present invention are set forth below.

Finished Product Properties

| | | Acceptance Criteria | | | | | | | | | | | |
|---|---|---|---|---|---|---|---|---|---|---|---|---|---|
| | Sample | Individual | | | Average | | | | Test | | | | Measuring |
| Physical Test | Size | Min | Target | Max | Min | Target | Max | Units | Method | Freq | CTQ | Value | Equipment |
| Dollops Total | | 10 | 20 | 30 | | | | | | | | | |
| Percent Yield for ISI | | 75 | 85 | 95 | | | | Percent | | | | | |
| Temperature at packaging | | 45 | 50 | 50 | | | | Degrees F. | | | | | |
| Whip Temperature, Product | | 40 | 45 | 50 | | | | Degrees F. | | | | | |
| Before Whip | | | | | | | | | | | | | |

Chemical

| | | Acceptance Criteria | | | | | | | | | | | |
|---|---|---|---|---|---|---|---|---|---|---|---|---|---|
| | Sample | Individual | | | Average | | | | Test | | | | Measuring |
| Parameter | Size | Min | Target | Max | Min | Target | Max | Units | Method | Freq | CTQ | Value | Equipment |
| Fat, total % | | 22.15 | 23.15 | 24.15 | | | | Percent | | | | | |
| Solids, Total % | | 43.38 | 45.38 | 47.38 | | | | Percent | | | | | |

Microbiological

| | Sample | Acceptance Criteria | | RPC Test | Test | | | | Measuring |
|---|---|---|---|---|---|---|---|---|---|
| Parameter | Size | Limit | Units | Method | Method | Freq | CTQ | Value | Equipment |
| Coliforms | | 20 | cfu/gram | | | | | | |
| E. Coli | | Negative | cfu/gram | | | | | | |
| Mold | | 100 | cfu/gram | | | | | | |
| Standard Plate Count | | 20,000 | cfu/gram | | | | | | |
| Yeast | | 100 | cfu/gram | | | | | | |

The edible topping composition of the present invention can be formed into a whipped topping using any mechanical device which can exert a high shear mechanical force, such as a paddle, whip, traditional batch mixers, continuous mixers and the like.

The unwhipped edible topping composition can be subjected to various aseptic processing such as thermal treatment to produce a commercially sterile product. Such processes are well known to those skilled in the art and include high temperature short time (HTST), extended shelf life and UHT thermal treatment, homogenization, cooling and packaging. A variety of whipped confections can be made from the edible topping composition. Such whipped confections include fillings, icings, toppings, decorations and the like which can be used for cakes, pies, cookies and the like.

The edible topping composition can be used with whip topping canisters (e.g., iSi canisters).

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. A whipped food product comprising 5-40 wt % coconut component, 40-70 wt % water, 0.5-20 wt % fat that is absent said coconut component, 1-35 wt % sweetener, 0-5 wt % emulsifier, 0-5 wt % stabilizer, 0-1 wt % salt, 0-1 wt % acidulant, and 0-1 wt % flavoring, said whipped food product having an overrun of at least 150% and is stable in its whipped form for at least 12 hours at a temperature of no less than 33° F.

2. The whipped food product as defined in claim 1, wherein said coconut component includes one or more ingredients selected from the group consisting of coconut oil, coconut cream, and coconut milk.

3. The whipped food product as defined in claim 1, wherein said coconut component includes two or more ingredients selected from the group consisting of coconut oil, coconut cream, and coconut milk.

4. The whipped food product as defined in claim 1, wherein said fat is a non-dairy fat, said fat includes one or more fats selected from the group consisting of non-dairy butter, cottonseed oil, corn oil, soybean oil, peanut oil, olive oil, palm oil, palm kernel oil, safflower oil, sunflower oil, avocado oil, mustard oil, peanut oil, rice bran oil, and sesame oil.

5. The whipped food product as defined in claim 1, wherein said emulsifier is present in an amount of at least 0.01 weight percent.

6. The whipped food product as defined in claim 1, wherein said stabilizer is present in an amount of at least 0.01 weight percent.

7. The whipped food product as defined in claim 1, wherein said salt is present in an amount of at least 0.01 weight percent.

8. The whipped food product as defined in claim 1, wherein said acidulant is present in an amount of at least 0.001 weight percent.

9. The whipped food product as defined in claim 1, wherein said flavoring is present in an amount of at least 0.01 weight percent.

10. The whipped food product as defined in claim 1, comprising by weight percent:

| | |
|---|---|
| Water | 40-70% |
| Coconut oil | 5-30% |
| Creamed coconut and/or | 0-10% |
| coconut milk | |
| Non-dairy fat | 0-20% |
| Sweetener | 1-35% |
| Emulsifier | 0.01-5 |
| Stabilizer | 0.01-5 |
| Salt | 0.01-1% |
| Flavoring | 0.01-1% |
| Acidulant | 0.001-1%. |

11. The whipped food product as defined in claim 1, comprising by weight percent:

| | |
|---|---|
| Water | 45-60% |
| Coconut oil | 10-20% |
| Creamed coconut and/or | 0-10% |
| coconut milk | |
| Sunflower oil | 1-10% |
| Non-dairy butter | 0-10% |
| Sweetener | 1-15% |
| Sweetener (syrup) | 1-20% |
| Emulsifier | 0.1-2% |
| Stabilizer | 0.1-2% |
| Salt | 0.05-1% |
| Flavoring | 0.05-1% |
| Acidulant | 0.001-0.5%. |

12. The whipped food product as defined in claim 1, comprising by weight percent:

| | |
|---|---|
| Water | 50.01-55% |
| Coconut oil | 12-16% |
| Creamed coconut and/or | 0-10% |
| coconut milk | |
| Sunflower oil | 4-8% |
| Non-dairy butter | 0-6% |
| Sugar | 4-8% |
| Sweetener (syrup) | 12-18% |
| Emulsifier | 0.3-0.8% |
| Stabilizer | 0.1-0.4% |
| Salt | 0.05-0.2% |
| Flavoring | 0.1-0.5% |
| Acidulant | 0.01-0.05%. |

13. The whipped food product as defined in claim 1, comprising by weight percent:

| | |
|---|---|
| Water | 47-52% |
| Coconut oil | 12-16% |
| Creamed coconut | 0.01-10% |
| Sunflower oil | 4-8% |
| Non-dairy butter | 0-6% |
| Sugar | 6-12% |
| Sweetener (syrup) | 12-18% |
| Emulsifler | 0.3-0.9% |
| Stabilizer | 0.1-0.4% |
| Salt | 0.05-0.2% |
| Flavoring | 0.1-0.8% |
| Acidulant | 0.01-0.05%. |

14. The whipped food product as defined in claim 1, comprising by weight percent:

| | |
|---|---|
| Water | 48-56% |
| Coconut oil | 10-16% |
| Syrup Solids | 12-18% |
| Sugar | 3-10% |
| Sunflower oil | 2-8% |
| Creamed coconut | 2-8% |
| Emulsifier | 0.2-1.2% |
| Stabilizer | 0.1-0.43% |
| Salt | 0.05-0.2% |
| Flavoring | 0.05-2% |
| Acidulant | 0.01-0.04%. |

15. A method for making a whipped edible topping composition having an overrun of at least 150% and is stable in its whipped form for at least 12 hours at a temperature of no less than 33° F., said method comprising the steps of:
a. forming a mixture that comprises 5-40 wt % coconut component, 40-70 wt % water, 0.5-20 wt % fat that is absent said coconut component, 1-35 wt % sweetener, 0-5 wt % emulsifier, 0-5 wt % stabilizer, 0-1 wt % salt, 0-1 wt % acudulent, and 0-1 wt % flavoring; and,
b. whipping said mixture to form said whipped edible topping composition having an overrun of at least 150% and is stable in a whipped form with said overrun of at least 150% for at least 12 hours in a temperature of no less than 33° F.

16. The method as defined in claim 15, including the steps of:
i. heating said mixture to a temperature of at least 130° F. for at least 5 seconds;
ii. pasteurizing said mixture at a temperature of at least 130° F. for at least 1 minute;
iii. cooling said mixture to below 110° F.; and,
iv. homogenizing said mixture.

17. The method as defined in claim 15, including the steps of:
i. heating said mixture to a temperature of 130-200° F. for 10 seconds to 10 minutes;
ii. pasteurizing said mixture at a 130-200° F. for 1-20 minutes;
iii. cooling said mixture to 40-100° F. for 10 seconds to 20 minutes; and,
iv. homogenizing said mixture.

18. The method as defined in claim 15, wherein said coconut component in said mixture includes one or more ingredients selected from the group consisting of coconut oil, coconut cream, and coconut milk.

19. The method as defined in claim 15, wherein said coconut component in said mixture includes two or more ingredients selected from the group consisting of coconut oil, coconut cream, and coconut milk.

20. The method as defined in claim 15, wherein said fat in said mixture is a non-dairy fat, said fat includes one or more fats selected from the group consisting of non-dairy butter, cottonseed oil, corn oil, soybean oil, peanut oil, olive oil, palm oil, palm kernel oil, safflower oil, sunflower oil, avocado oil, mustard oil, peanut oil, rice bran oil, and sesame oil.

21. The method as defined in claim 15, wherein said emulsifier in said mixture is present in an amount of at least 0.01 weight percent.

22. The method as defined in claim 15, wherein said stabilizer in said mixture is present in an amount of at least 0.01 weight percent.

23. The method as defined in claim 15, wherein said salt in said mixture is present in an amount of at least 0.01 weight percent.

24. The method as defined in claim 15, wherein said acidulant in said mixture is present in an amount of at least 0.001 weight percent.

25. The method as defined in claim 15, wherein said flavoring in said mixture is present in an amount of at least 0.01 weight percent.

26. The method as defined in claim 15, wherein said mixture comprising by weight percent:

| | |
|---|---|
| Water | 40-70% |
| Coconut oil | 5-30% |
| Creamed coconut and/or | 0-10% |
| coconut milk | |
| Non-dairy fat | 0-20% |
| Sweetener | 1-35% |
| Emulsifier | 0.01-5 |
| Stabilizer | 0.01-5 |
| Salt | 0.01-1% |
| Flavoring | 0.01-1% |
| Acidulant | 0.001-1%. |

27. The method as defined in claim 15, wherein said mixture comprising by weight percent:

| | |
|---|---|
| Water | 45-60% |
| Coconut oil | 10-20% |
| Creamed coconut and/or | 0-10% |
| coconut milk | |
| Sunflower oil | 1-10% |
| Non-dairy butter | 0-10% |
| Sweetener | 1-15% |
| Sweetener (syrup) | 1-20% |
| Emulsifier | 0.1-2% |
| Stabilizer | 0.1-2% |
| Salt | 0.05-1% |
| Flavoring | 0.05-1% |
| Acidulant | 0.001-0.5%. |

28. The method as defined in claim 15, wherein said mixture comprising by weight percent:

| | |
|---|---|
| Water | 50.01-55% |
| Coconut oil | 12-16% |
| Creamed coconut and/or | 0-10% |
| coconut milk | |
| Sunflower oil | 4-8% |
| Non-dairy butter | 0-6% |
| Sugar | 4-8% |
| Sweetener (syrup) | 12-18% |
| Emulsifier | 0.3-0.8% |
| Stabilizer | 0.1-0.4% |
| Salt | 0.05-0.2% |
| Flavoring | 0.1-0.5% |
| Acidulant | 0.01-0.05%. |

29. The method as defined in claim 15, wherein said mixture comprising by weight percent:

| | |
|---|---|
| Water | 47-52% |
| Coconut oil | 12-16% |
| Creamed coconut | 0.01-10% |
| Sunflower oil | 4-8% |
| Non-dairy butter | 0-6% |
| Sugar | 6-12% |
| Sweetener (syrup) | 12-18% |
| Emulsifier | 0.3-0.9% |
| Stabilizer | 0.1-0.4% |
| Salt | 0.05-0.2% |
| Flavoring | 0.1-0.8% |
| Acidulant | 0.01-0.05%. |

30. The method as defined in claim 15, wherein said mixture comprising by weight percent:

| | |
|---|---|
| Water | 48-56% |
| Coconut oil | 10-16% |
| Syrup Solids | 12-18% |
| Sugar | 3-10% |
| Sunflower oil | 2-8% |
| Creamed coconut | 2-8% |
| Emulsifier | 0.2-1.2% |
| Stabilizer | 0.1-0.43% |
| Salt | 0.05-0.2% |
| Flavoring | 0.05-2% |
| Acidulant | 0.01-0.04%. |
